(19) United States
(12) Patent Application Publication
(10) Pub. No.: US 2008/0246361 A1
(43) Pub. Date: Oct. 9, 2008

(54) POWER GENERATION DEVICE

(76) Inventor: David A. LaPoint, Los Angeles, CA (US)

Correspondence Address: Rutan & Tucker, LLP., 611 ANTON BLVD, SUITE 1400, COSTA MESA, CA, 92626, US

(21) Appl. No.: 12/013,350

(22) Filed: Jan. 11, 2008

Related U.S. Application Data
(60) Provisional application No. 60/880,564, filed on Jan. 12, 2007.

(51) Int. Cl. H02K 21/12

(52) U.S. Cl. 310/156.01

(57) ABSTRACT

A device with the ability to harness electrical power utilizing magnetic arrays and electrically charged particulate to produce electrical power is provided. The present invention provides a device and system whereby the device may utilize a magnetic array to produce a electronic field that may collected in the form of electric energy. Moreover, the present invention provides a device having power generation effects whereby the device utilizes an arrangement of magnets on a magnetic array and a voltage ring having an input and an output connection to allow for discharge of collected electrical energy.

### PRIORITY CLAIM

The patent claims priority to the earlier filed U.S. Provisional Application No. 60/880,564 filed on Jan. 12, 2007.

### FIELD OF THE INVENTION

The present invention relates generally to a power generator. More specifically, the field of invention is to a power generator device that may utilize an electric and magnetic field.

### BACKGROUND

Electrical power is one of the most important components of our everyday lives. We use electrical energy to almost everything, from electronics, to water heaters, to light bulbs and even cars. However, generating the electrical power that we need has not always been an easy process. Most of our electrical power is generated by burning coal and/or from hydroelectric generation. Burning coal can be expensive and may have adverse effects on the environment, wherein the environmental effects of hydro-electric generation are not as extreme, but may still disrupt a very fragile eco-system.

Hydro-electricity generators change the energy of moving water into electrical energy. The generators may produce electrical current by using a continuous flow of water to turn a water turbine that is connected to an electricity generator and/or alternator. Water flows from a dam or reservoir to the turbine through a huge pipe called a penstock. The water passes through a spiral-shaped pipe making it spin. The spinning water makes the turbine turn. In order to maintain consistency, the speed of the turbine should remain constant so that the amount of electrical energy being produced remains the same at all times. Any fluctuation in the amount of electrical energy being produced could cause instability and breakdown of the generators and/or circuits and capacitors used to contain and store the electrical energy produced. The amount of electricity that may be produced from hydro-electric generation may depend on the rate on which the water flows and the difference in height between the water in the top of the dam or reservoir and the water in the lower part for the reservoir below the turbine.

However, as more and more hydroelectric stations go up, so do the number of dams and reservoirs necessary to facilitate the hydroelectric generation process. The increased number of dams and reservoirs have an adverse affect on the environment around them, by swamping lush growing land, and disrupting the natural flow of water. Moreover, the institution of dams and reservoirs disrupts the natural eco-system of an area by creating and/or destroying natural eco-systems.

A newer energy generator has been to use the electric properties of a magnet to produce electrical power. More specifically, every electron is essentially a small magnet. The combination of a plurality of electrons may create a magnetic field. This magnet field is typically caused by the electron's orbital motion about the nucleus and may produce as a by-product a limited electrical field. If this electrical field is properly harnessed, it may be able to produce sufficient power to be useable by an individual.

Therefore, what is needed is a power generation device that produces sufficient power while utilizing magnetic power and without the need for significant power input. Further, a device is needed that may produce sufficient power without the need for elaborate and costly electric generation devices.

### SUMMARY OF THE INVENTION

The present invention provides a device with the ability to harness electrical power from magnetic manipulation of same. Additionally, the present invention provides a device and system whereby the device may utilize a magnetic array to produce a electronic field that may collected in the form of electric energy. Moreover, the present invention provides a device having power generation effects whereby the device utilizes an arrangement of magnets to change the flow of ions and/or electrons to produce a change in the magnetic field and thereby allow for productions of electrical current from same.

To this end, in an exemplary embodiment of the present invention an apparatus for generation of power is provided. The apparatus has a chamber having at least a first side and a second side and a plurality of magnets contained within the chamber whereby the magnets form a magnetic array. Moreover, the apparatus has at least a ground rod and a voltage ring having at least an input connection point and an output connection point.

In an exemplary embodiment, the apparatus is constructed of metal.

In an exemplary embodiment, the apparatus is constructed of polycarbonate.

In an exemplary embodiment, the apparatus has a chamber that contains a plurality of magnetic arrays.

In an exemplary embodiment, the apparatus has a voltage ring wherein the voltage ring receives produced energy from a fusion reaction and outputs said produced energy through the output connection.

In an exemplary embodiment, the apparatus further comprises a plurality of fusion orifices.

In an exemplary embodiment, the apparatus has a chamber wherein the chamber utilizes a vacuum to produce energy.

In an exemplary embodiment, the apparatus operates by use of charged particles in the air.

In an exemplary embodiment, the apparatus has a plurality of feed tubes.

In an exemplary embodiment, the apparatus has a plurality of focus nozzles.

In an exemplary embodiment, the apparatus has a plurality of feed tubes that are surrounded by the magnetic arrays.

In an exemplary embodiment, the apparatus has a plurality of magnetic arrays wherein the magnetic arrays are formed with anisotropic rare-earth magnets in a pre-determined alignment.

In an exemplary embodiment, the apparatus has a voltage ring wherein the high voltage ring is held to a high pulsed DC voltage through the input connection point.

In an exemplary embodiment, the apparatus has an output connection point wherein the output connection point is connected to a bolt and a ground which allows discharge of power from the high voltage ring.

Among the many different possibilities contemplated, the apparatus may allow for multiple configurations of the apparatus whereby the apparatus may be made of varying sizes.

In another exemplary embodiment, it is contemplated that the apparatus may have therapeutic effects including the treatment of harmful electromagnetic fields in the body.

In yet another exemplary embodiment, it is contemplated that the apparatus may have a plurality of magnets contained thereon.

Still a further exemplary embodiment contemplates where the apparatus may have a plurality of magnets contained thereon, wherein the magnets may be contained in a plurality of rows.

In a further exemplary embodiment, it is contemplated that the apparatus may have a plurality of magnets contained thereon wherein the magnets may be contained in a plurality of rows wherein the number of rows may range in number.

A further exemplary embodiment contemplates that the apparatus may be constructed of a suitable material such as plastic.

In another exemplary embodiment, it is contemplated that the apparatus may be constructed of any suitable material such as metal, alloy and the like.

Further, a contemplated embodiment of the apparatus may be constructed of a suitable material such as rubber, foam, composite, plastic and the like, whereby the device may be rigid enough to provide support for the magnets contained thereon.

Additionally, in an exemplary embodiment, the apparatus may have at least a chamber portion and a collection receptacle.

A further exemplary embodiment of the present invention may include an apparatus whereby the apparatus may have a plurality of magnets whereby the magnets are oriented in a position to produce sufficient ion/electron flow of the magnets which may be collected in the form of electrical power.

A further exemplary embodiment of the present invention may include an apparatus wherein the apparatus may have chamber containing the magnets and magnetic arrays.

In yet another exemplary embodiment of the present invention, the apparatus may have a plurality of magnets whereby the magnets may be oriented onto a magnetic array which in turn is connected to a ground rod.

In an exemplary embodiment of the present invention, an apparatus may be provided whereby the apparatus may have a plurality of magnets, whereby the magnets may have differing strengths and/or magnetic fields which alters the ion/electron flows.

Another exemplary embodiment of the present invention may include an apparatus whereby the apparatus may have a plurality of magnets whereby the magnets are arranged in a specific pattern within a chamber.

In yet another exemplary embodiment of the present invention, an apparatus is provided whereby the apparatus may have a plurality of magnets arranged in a helical pattern within a receptacle whereby the entire receptacle may be rotated which may produce a higher electromagnetic field generated by the entire apparatus.

Still another exemplary embodiment of the present invention is to provide an apparatus

whereby the apparatus may have at least a high voltage ring therein which may be mounted in a high voltage ring mount.

Another exemplary embodiment of the present invention may include an apparatus whereby the apparatus may input connection point and an output connection point.

In yet another exemplary embodiment of the present invention, an apparatus may be provided whereby the apparatus may have a plurality of magnetic arrays.

In a further exemplary embodiment, an apparatus may be provided whereby the apparatus may have a plurality of magnetic arrays that are formed with anisotropic rare-earth magnets having distinct alignments.

Still a further exemplary embodiment of the present invention is to provide an apparatus whereby the apparatus may have magnetic arrays that are aligned with north poles in, and may also have magnetic arrays that are aligned in south poles in.

Yet another exemplary embodiment of the present invention may include an apparatus whereby the apparatus may have a plurality of ground rods.

In yet another exemplary embodiment of the present invention, apparatus may be provided whereby the apparatus may have an output connection point that is connected to a stainless steel bolt having a gap from another bolt connected to the ground.

Still a further exemplary embodiment of the present invention is to provide an apparatus whereby the apparatus may have a chamber unit which is constructed of polycarbonate.

In an exemplary embodiment, an apparatus may be provided whereby the apparatus may have a plurality of arrays that spin to produce energy products.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a perspective view of the invention in an exemplary embodiment of the present invention;

FIG. 2 is a perspective view of the invention in an exemplary embodiment of the present invention;

FIG. 3 is a close-up view perspective view of the invention in an exemplary embodiment of the present invention;

FIG. 4 is a side cross-sectional side view of the invention in an exemplary embodiment of the present invention;

FIG. 5 is a perspective cross-sectional view of the invention illustrating the entire apparatus in an exemplary embodiment of the present invention;

FIG. 6 is a close-up perspective view of the invention in an exemplary embodiment of the present invention;

FIG. 7 is a plurality of views of the invention in an exemplary embodiment of the present invention;

FIG. 8 is a top cross-sectional view of the invention in an exemplary embodiment of the present invention;

FIG. 9 is a perspective cross-sectional view of the invention in an exemplary embodiment;

FIG. 10 is a side cross-sectional view in an exemplary embodiment of the present invention; and

FIG. 11 is an alternative exemplary embodiment of the power generator apparatus having external magnets arranged around the power generator apparatus.

### DETAILED DESCRIPTION OF AN EXEMPLARY EMBODIMENT

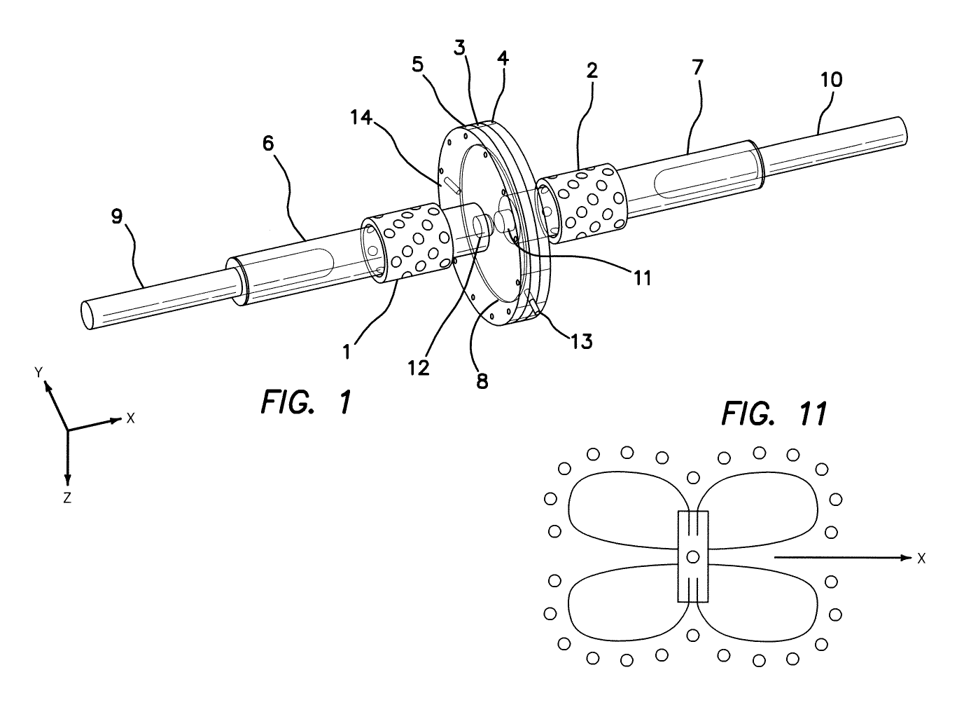

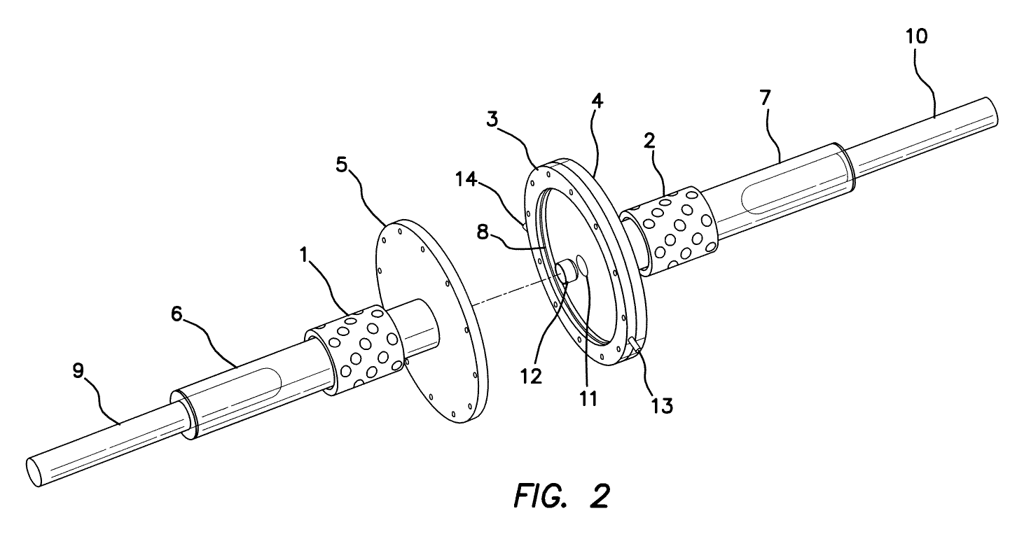

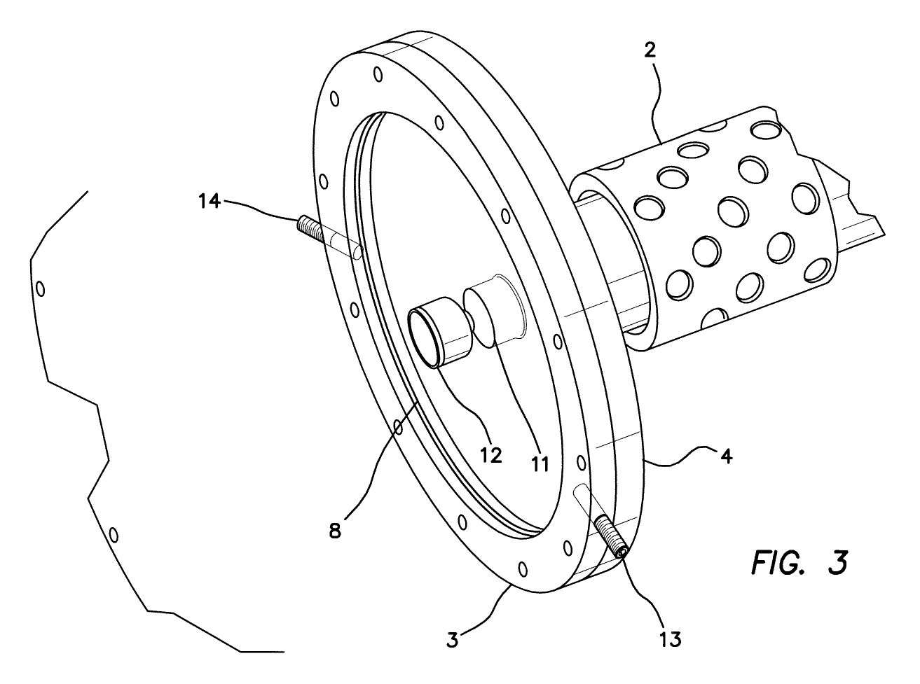

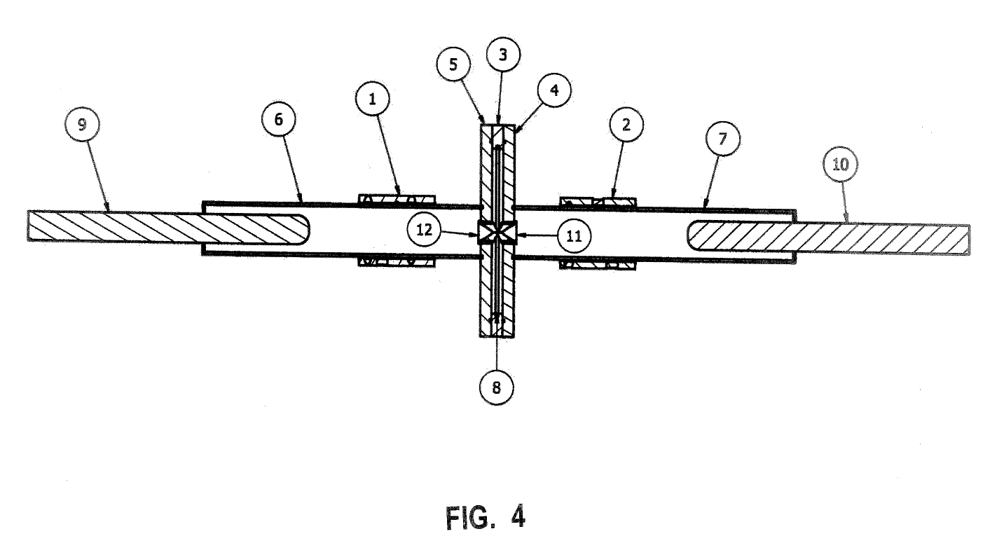

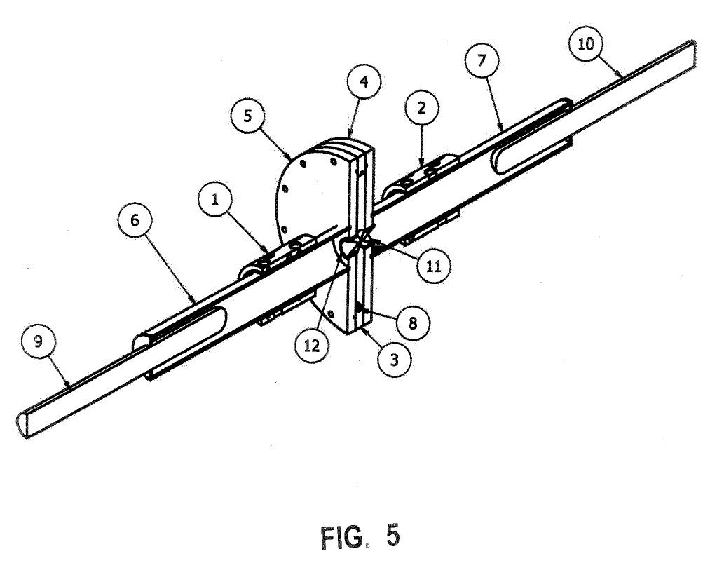

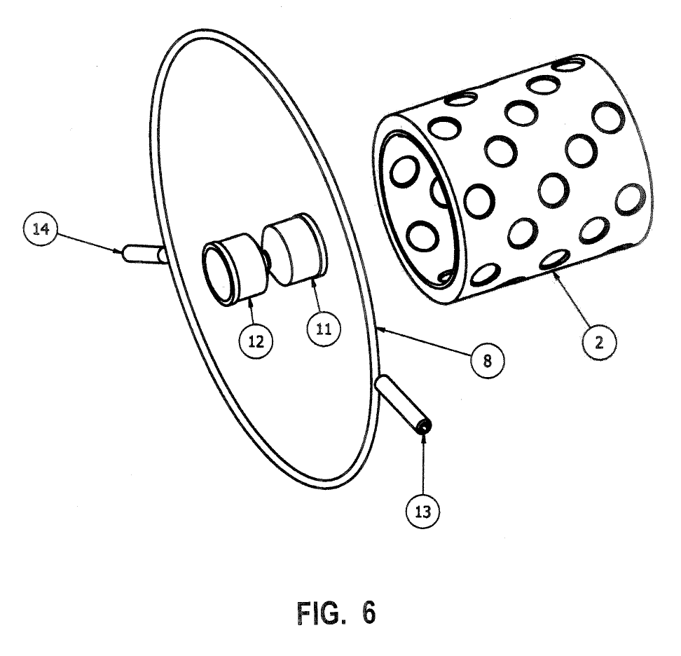

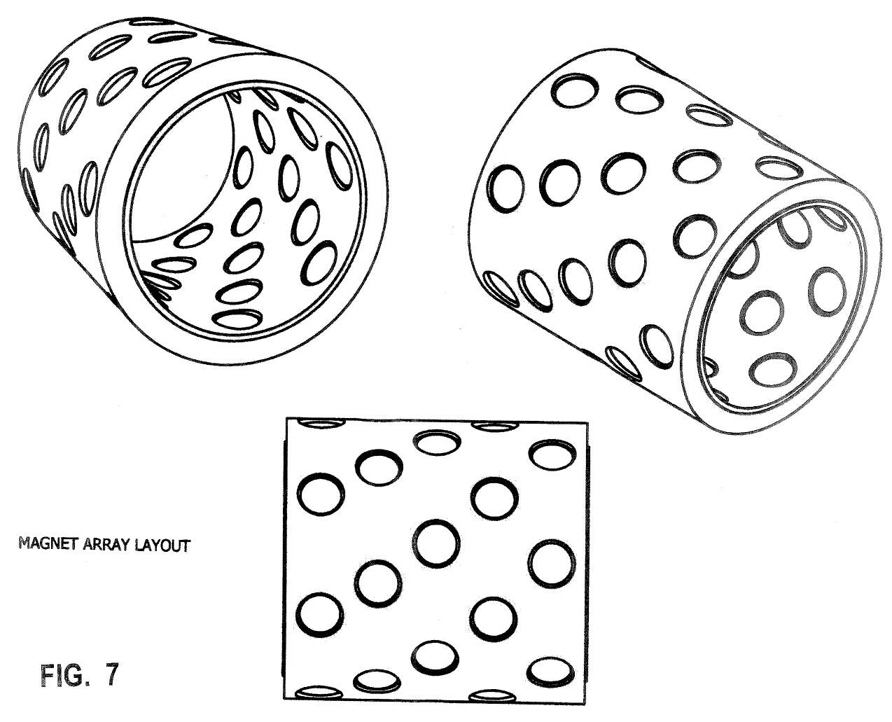

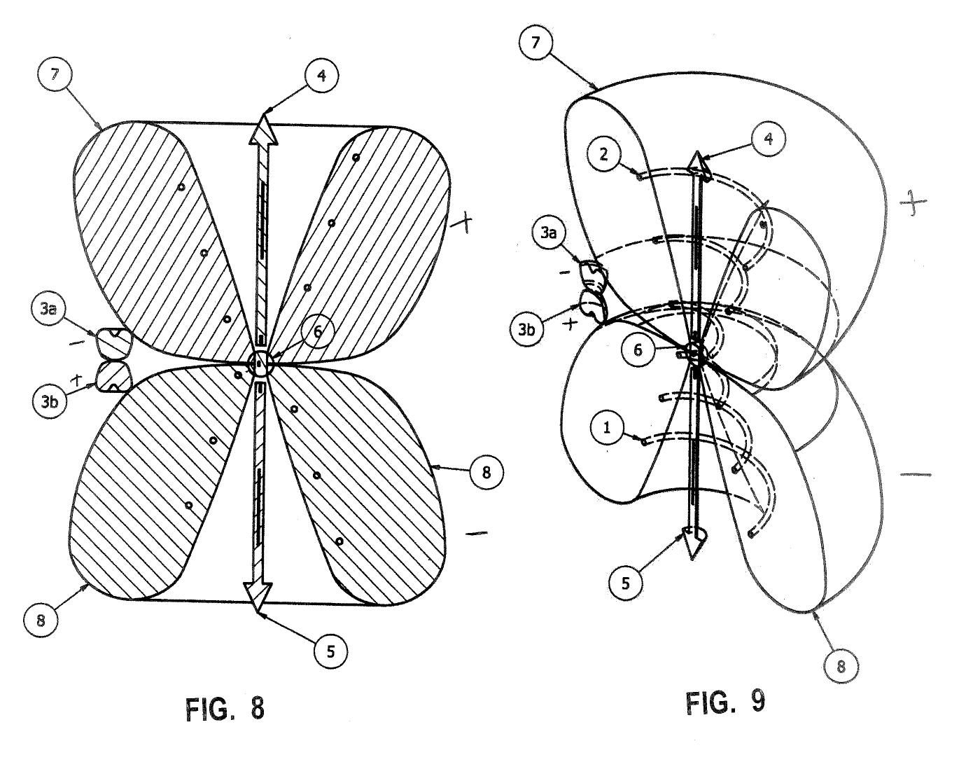

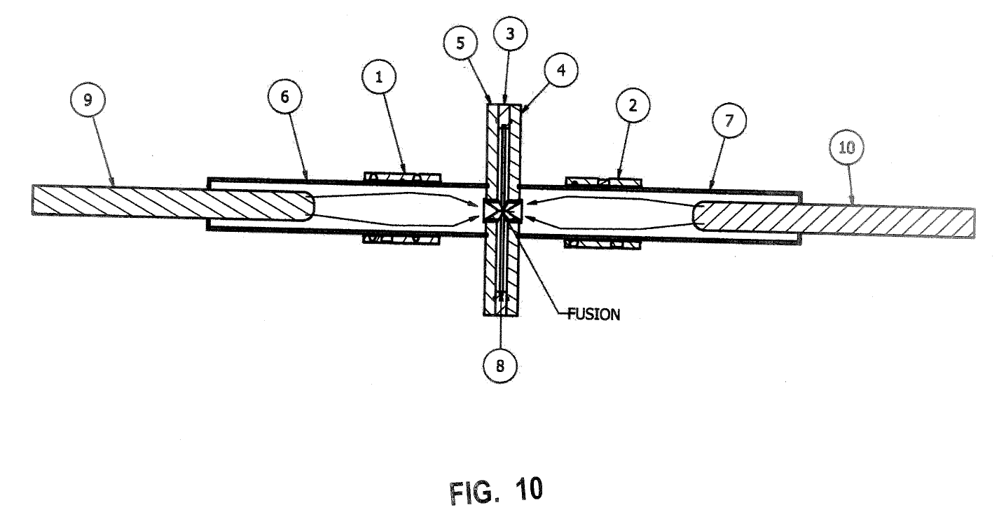

FIGS. 1-10 show a power generator apparatus according to an exemplary embodiment of the present invention. High voltage ring 8 is mounted within a high voltage ring mount 3. The high voltage ring 8 is formed of stainless steel, but may be formed of any type of metal, including metal of high conductivity, such as copper. The high voltage ring 8 may have any radius, but in the exemplary embodiment of FIG. 1, the high voltage ring 8 has a diameter of about seven inches. The high voltage ring 8 includes input connection point 14 and output connection point 13. Right and left side chamber covers 4, 5 are mounted to the high voltage ring mount 3. The right and left side chamber covers 4, 5 and the high voltage ring mount 3 provide an encapsulated cylinder extending about two inches in length. Holes are located in each center portion on each end of the chamber covers 4, 5. Mounted into each of the holes are Macor® focus nozzles 11, 12. Macor® is a registered trademark of Corning, Inc. Macor® is a machinable glass ceramic white material that looks somewhat like porcelain. Macor has excellent thermal characteristics, acting as efficient insulation, and stable up to temperatures of 1000° C., with very little thermal expansion or outgassing.

Left and right side feed tubes 6, 7 are aligned in an x direction, such that a surface of the feed tubs 6, 7 and focus nozzles 11, 12 are defined by a radius r extending in an y, z direction, rotating about the x axis. Right and left side ground rods 9, 10 are affixed within the right and left side feed tubes 6, 7, respectively. Magnetic arrays 1, 2 surround the left and right side feed tubes 6, 7, respectively, at one end close to the chamber covers 4, 5 and high voltage ring mount 3. The ground rods 9, 10, feed tubs 6, 7 and magnetic arrays 1, 2 are aligned to extend in the x direction. The high voltage ring 8 is aligned so as to extend only in the y and z directions as the ring is traversed, with its thickness extending in the x direction. The magnetic arrays 1, 2 are formed with anisotropic rare-earth magnets having an alignment as shown in FIG. 1. That is, the alignment of the magnets extend diagonally from ends of the magnetic array cylinders 1, 2. Magnets in magnetic array 1 are aligned with north poles in. Magnets in magnetic array 2 are aligned with south poles in.

An operation of the power generator apparatus will now be described. The ground rods 9, 10 are at ground. The high voltage ring 8 is held to a high pulsed DC voltage of around 100 kV 25 through input connection point 13. When output connection point 14 is connected to a stainless steel bolt having about a one inch gap from another stainless steel bolt connected to ground, current flow is about 700 p.A. The charge difference causes a flow from ground rods 9, 10 through orifices 11, 12, and out to high voltage ring 8.

As the matter passes through the magnet arrays 1, 2 the fields of each particle are aligned so as to enter fusion orifices 11, 12 with opposite charge fields toward each other so that the matter entering from the left side is attracted to the matter from the right side. This results in fusion and a great release of energy. Parts 6, 7, 3, 4, and 5 form an airtight chamber on which a vacuum can be pulled. The unit can be operated at atmospheric pressure and produce energy with no moving parts.

The chamber unit could be constructed of many different materials. In an exemplary embodiment, the unit can be formed of polycarbonate, but a flexible fabric could be used for atmospheric operation.

When a vacuum is pulled to 30″ HG, the visible flow inside the chamber is visible as a beryl colored glow. The flow appears as counter rotating tornadoes. The flow extends from both the right and left sides down through the orifices 11, 12, and then exploding out into many (thousands plus) flow streams out to the high voltage ring. Because of the fusion reaction, the high voltage ring 8 receives the produced energy in the form of electricity which is output from 13. The fields produced by the power generator apparatus are very large in comparison to the machine side, total machine size is 4′ long, with a 7″ diameter high voltage ring 8. The fields produced by power generator apparatus fill an entire 7700 sq. ft. building with a 20′ ceiling.

The fields obey the principles of the structure of matter as outlined earlier. These fields possess a great ability to clean the air way beyond normal electrostatic air cleaners. These charged fields are also great for human, animal, life, etc. Within the 7700 sq. ft. building there is an amazing air quality. The magnetic arrays can be spun to increase the rate of fusion.

Design of arrays to be optimized probably at tornado like shape would be the optimum. The fields could also possibly be confined into a smaller high density, high energy unit per sketch K of FIG. 11.

The unit presently is operating on air, but other gases or dopants could be used as well. Higher feed voltages should result in more energy products, per given space. Changing 5 components to other materials might increase output as well.

The spinning magnetic arrays also produce some very interesting benefits for straightening kinked fields within the human body, sore muscles, and other body issues can be fixed in minutes at times, sometimes in seconds. Larger arrays will work for the whole body.

What is claimed is:

1. An apparatus for generation of power, the apparatus comprising:
a chamber having at least a first side and a second side;
a plurality of magnets contained within the chamber whereby the magnets form a magnetic array;
at least a ground rod; and
a voltage ring having at least an input connection point and an output connection point.

2. The apparatus described in claim 1 wherein said apparatus is constructed of metal.

3. The apparatus described in claim 1 wherein said apparatus is constructed of polycarbonate.

4. The apparatus described in claim 1 wherein said chamber contains a plurality of magnetic arrays.

5. The apparatus described in claim 1 wherein said voltage ring receives produced energy from a fusion reaction and outputs said produced energy through the output connection.

6. The apparatus described in claim 1 further comprising: a plurality of fusion orifices.

7. The apparatus described in claim 1 wherein the chamber utilizes a vacuum to produce energy.

8. The apparatus described in claim 1 wherein the apparatus operates by use of charged particles in air.

9. The apparatus described in claim 1 further comprising: a plurality of feed tubes.

10. The apparatus described in claim 1 further comprising: a plurality of focus nozzles.

11. The apparatus described in claim 1 having a plurality of feed tubes that surrounded by the magnetic arrays.

12. The apparatus described in claim 1 wherein the magnetic arrays are formed with anisotropic rare-earth magnets in a pre-determined alignment.

13. The apparatus described in claim 1 wherein the high voltage ring is held to a high pulsed DC voltage through the input connection point.

14. The apparatus described in claim 1 wherein the output connection point is connected to a bolt and a ground and allows discharge of power from the high voltage ring.
